(19) United States
(12) Patent Application Publication
(10) Pub. No.: US 2004/0232061 A1
(43) Pub. Date: Nov. 25, 2004

(54) Liquid transfer system for dialysis chemicals

(76) Inventor: Jack R. Dillon, Overland Park, KS (US)

Correspondence Address: Ginnie C. Derusseau, Chase Law Firm, L.C., 4400 College Boulevard, Suite 130, Overland Park, KS, 66211, US

(21) Appl. No.: 10/819,462

(22) Filed: Apr. 7, 2004

Related U.S. Application Data
(60) Provisional application No. 60/460,898, filed on Apr. 7, 2003.

(51) Int. Cl. B01D 63/00

(52) U.S. Cl. 210/257.2; 141/35; 141/392

(57) ABSTRACT

The liquid transfer apparatus includes a liquid storage drum, a liquid transfer structure on said storage drum and a transfer container positionable on the liquid transfer structure. The liquid transfer structure includes a pump, a level sensor and a riser hose member. The riser hose member has one end in the drum and another end in communication with the pump. The pump and the level sensor remove a desired amount of the liquid from the storage drum through the riser hose member into the transfer container. The riser hose member includes a rigid riser tube inserted into said drum, a free end of the riser tube resting on or adjacent a bottom surface of the drum, allowing the drum to be completely emptied of the liquid.

This application claims the priority of application for U.S. Letters Patent Serial No. 60/460,898, filed Apr. 7, 2003 entitled LIQUID TRANSFER SYSTEM FOR DIALYSIS CHEMICALS.

### FIELD OF THE INVENTION

This invention relates to a system for transferring the liquid chemicals used during dialysis from storage drums to a dialysis machine.

### BACKGROUND OF THE INVENTION

The major role of the kidneys is to remove waste products and excess fluid from the body through urine. They also regulate the body's salt, potassium, and acid content, and they produce hormones, including erythropoietin, which stimulates the production of red blood cells. When the kidneys' ability to remove and regulate water and chemicals is seriously impaired, waste products and excess fluid build up in the body, causing swelling and other symptoms. Dialysis is one way of replacing the critical function of failing kidneys, thereby sustaining life. Through dialysis, the blood is cleaned and filtered, ridding the body of harmful waste products and extra salts and fluids.

There are two types of dialysis: hemodialysis and peritoneal dialysis. In hemodiaylsis blood is passed through an artificial kidney called a dialyzer, outside the body. Peritoneal dialysis uses a filtering process similar to hemodialysis but uses a person's own peritoneal lining in the abdomen to do the filtering.

During hemodialysis the dialyzer includes a selectively permeable membrane which allows toxic fluids and waste to pass through. The fluid used to clean the blood is called dialysate. By controlling the chemicals in the dialysate, the dialysis machine controls the transfer of solutes according to the doctor's prescription. Dialysis machines control the chemicals in the dialysate by mixing dialysis fluid concentrates, which are strong versions of the chemicals, acetate or sodium bicarbonate plus other acid based solutions, with purified water.

Traditionally, such dialysis chemicals come in 55-gallon drums. To transfer the chemicals from the drum to the dialysis machine, a transfer jug is filled from the drum through one of the bungholes in the top of the drum using an inserted tube and a hand or electric pump. The jug is placed on the dialysis machine and the solution is drawn into the machine as needed.

This traditional transfer process has several disadvantages. If distracted while filling the bucket, overflow and spillage can occur. The chemicals can eat flooring, even concrete. Also, the drum spigot is typically not at the drum's lowest point, but is spaced up from the bottom of the drum. Thus, a drum is not generally completely emptied. Residual chemicals are left in the bottom of the drum. This traditional method is messy, corrosive and inefficient.

### BRIEF DESCRIPTION OF THE DRAWINGS

FIG. 1 is a perspective view of the liquid transfer system for dialysis chemicals in accordance with the present invention shown mounted to the lid of a drum containing such chemicals;

FIG. 2 is a front view of the liquid transfer system shown in FIG. 1 but with the riser assembly thereof removed from the drum for clarity and showing the transfer container in hidden lines;

FIG. 3 is a vertical sectional view taken along line 3-3 of FIG. 2;

FIG. 4 is a vertical sectional view taken along line 4-4 of FIG. 2; and

FIG. 5 is an electrical schematic diagram of the transfer system in accordance with the present invention.

### DETAILED DESCRIPTION

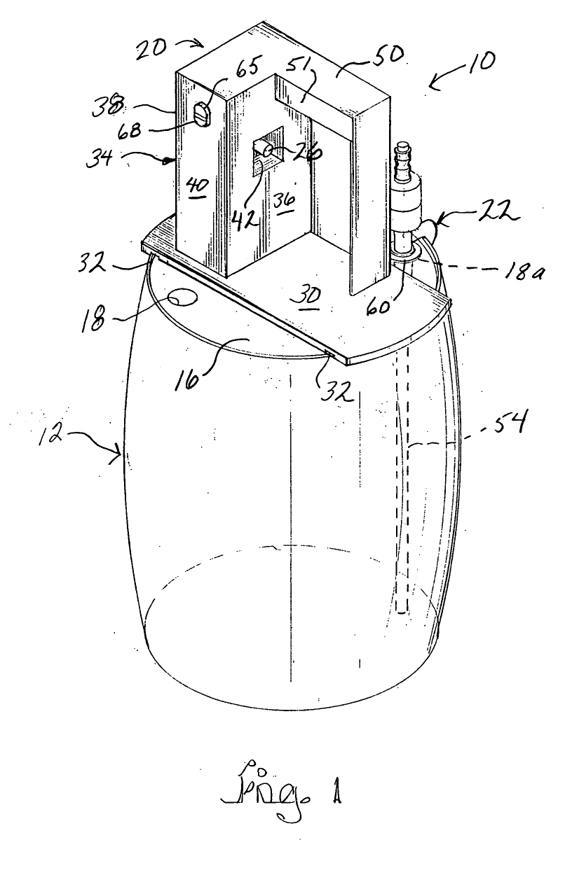

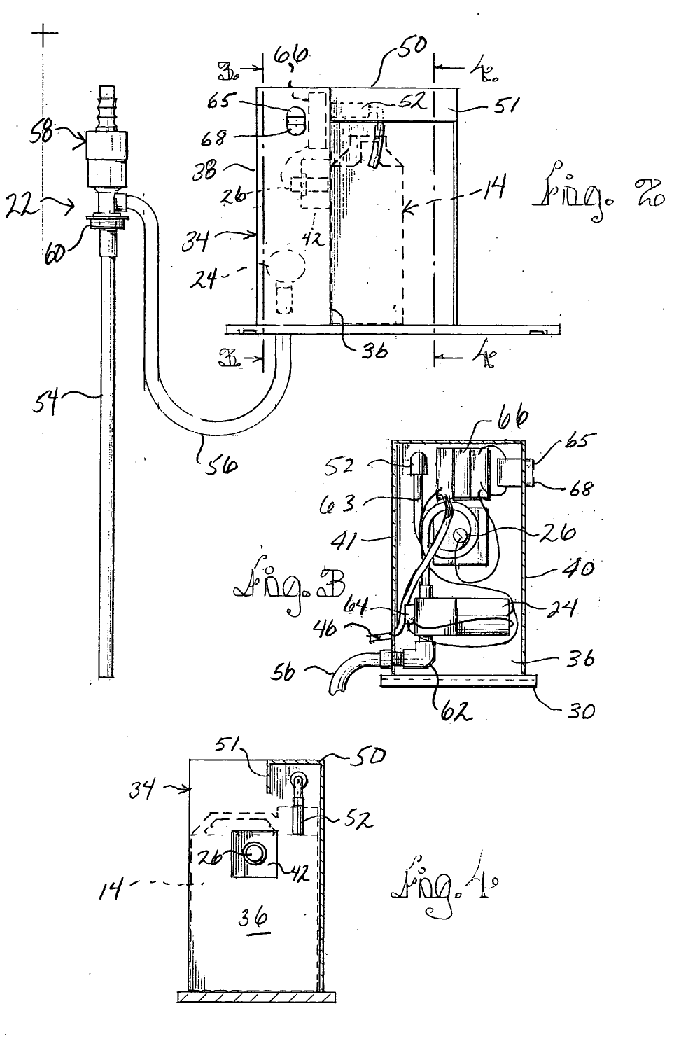

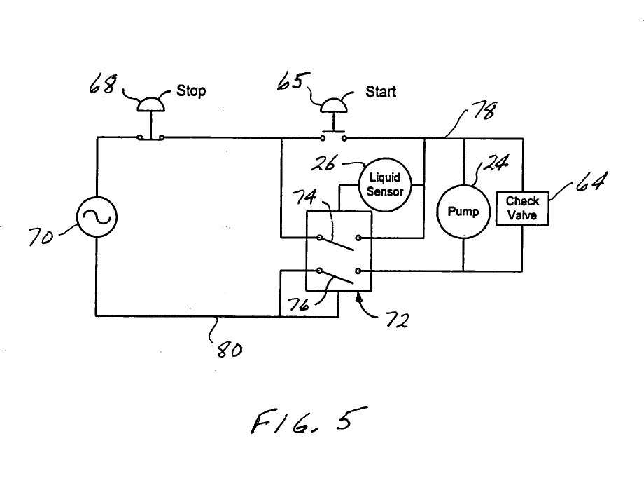

A liquid transfer system 10 for dialysis chemicals in accordance with the present invention is shown in FIG. 1. The dialysis chemicals are stored in the drum 12 and are pumped from the drum to a transfer container 14 for ultimate deposit in a dialysis machine (not shown). The transfer container is shown in broken lines in FIGS. 2 and 4.

Drums, such as drum 12, in which dialysis chemicals are typically stored have approximately a 55-gallon capacity and include a circular top lid 16 and two diametrically spaced bungholes 18 and 18a. The liquid transfer system 10 is mounted to the top lid 16 of the drum 12. The system 10 includes a specially configured body member 20, a conventional riser hose assembly 22, an electrically operated pump 24 (FIG. 3) and a level sensor 26.

The body member 20 includes a support shelf 30, which rests across the drum's lid 16. Specifically, as seen in FIG. 1, support shelf 30 has two grooves 32 formed in the bottom surface of the shelf 30, one groove being formed adjacent each end of the shelf for receiving opposed edges of the top lid 16. The body member 20 further includes a box-like housing 34 which is secured to and extends upwardly from one end of the support shelf 30 and a wing 50 which extends horizontally from the housing 34 and upwardly from the shelf 30. The pump 24 and level sensor 26 are mounted in the housing 34.

The housing 34 includes an inner wall 36, an outer wall 38 and a front wall 40. The inner wall 36 has a square recessed portion 42 within which the level sensor 26 extends. Wing 50 extends outwardly from the rear end of the inner wall 36 as may be appreciated from FIGS. 1 and 4, and has an inverted U-shaped upper portion that presents a depending front lip 51.

The rear wall 41 of housing 34 (FIG. 3) has apertures through which a supply hose 56 and a power cord 46 can extend. A pair of switch buttons 65 (start) and 68 (stop) are mounted on the front wall 40. The wing 50 and adjacent inner wall 36 cooperate to present a recessed area in which the transfer container 14 rests to hold it in position on the support shelf 30 adjacent the level sensor 26 and beneath an outlet spigot 52 that extends through inner wall 36 at its upper rear corner and downwardly behind lip 51.

As best shown in FIG. 2, the riser assembly 22 includes a riser tube 54, the hose 56 and connection tubing 63. The tube 54 is preferably formed of rigid plastic for insertion in the drum 12 through the bunghole 18a. The free end of the tube 54 extends to the bottom surface of the drum 12. A threaded cap 60 mounted to the opposite upper end of the tube 54 screws into bunghole 18a to secure the tube 54 in the drum 12.

The hose 56 is preferably formed of flexible tubing unitarily and integrally connected to the tube 54. The hose 56 extends from just above the threaded cap 60 through the rear wall 41 of the housing 34 and is secured to the intake of pump 24 by an elbow 62. The connection tubing 63 communicates the pump 24 with the spigot 52 (FIG. 3).

The riser assembly 22 typically includes a manual diaphragm pump 58, which is not used with the present invention. It is secured to the end of the tube 54 opposite the free end thereof and just above the connection with hose 56.

The pump 24 is preferably a conventional self-priming, diaphragm, automatic demand pump. In particular, the pump 24 may comprise a positive displacement three-chamber diaphragm pump provided with a check valve 64 that closes when the pump is not in operation to prevent reverse flow and maintain the liquid level in the hose 56. One suitable pump is the 2088 Series Diaphragm Pump, Model No. 2088-594-154, manufactured and sold by SHURflo® Pump Manufacturing Company. Of course, any suitable electrically controlled pump may be used.

A level sensor 26 is electrically connected to the pump 24 to control flow as will be discussed. Level sensor 26 is preferably a capacitance proximity switch which senses liquid levels through a tank wall. Such a sensor 26 has the ability to respond to a liquid level that it “sees” through a plastic container wall. Other types of level sensors may alternatively be used. The sensor 26 is mounted in the recessed portion 42 of the inner wall 36 of the box-like housing 34 at a level spaced above the support shelf 30 at the desired height. One such capacitance proximity switch is sold by Levelite under product No. GAL100100.

To assemble the liquid transfer system 10 as shown in FIG. 1, the bunghole 18a is opened in the lid 16 of drum 12 containing dialysis chemicals. The riser tube 54 of the assembly 22 is inserted through the bunghole 18a into the drum 12. The length of the tube 54 corresponds to the height of the drum 12 so that when installed, the bottom of the tube 54 is immediately adjacent or rests on the bottom of the drum 12. This allows the drum 12 to be completely emptied of chemicals. The tube 54 is secured in the bunghole 18a by the threaded cap 60.

The body member 20 is placed over the top lid 16 of the drum 12 with the grooves 32 receiving and engaging the edge of the top lid 16. Now, a plastic liquid transfer container 14 can be placed on top of the support shelf 30 such that it is held in place by the wing 50 of the body member 20, immediately adjacent the sensor 26 and with the mouth of the container 14 immediately beneath the outlet spigot 52, as shown in FIGS. 2 and 4.

Once the container 14 is properly positioned as illustrated and described above, it can be filled with the liquid chemicals contained in the drum 12. The pump 24 and sensor 26 are activated by depressing start button 65. The desired amount of liquid chemicals are pumped from the drum 12, through tube 54, hose 56, tubing 63 and spigot 52 and into the container 14. When the liquid chemicals reach the level at which the sensor 26 is mounted, the sensor 26 deactivates the pump 24 and immediately stops the flow of any liquid into the container 14, which may then be removed. If the user desires that the container be only partially filled, the stop button 68 may be depressed at the desired level.

The electrical operation and interaction of the pump 24 and sensor 26 are shown in the schematic diagram of FIG. 5. The system 10 may be operated from any available electrical power source such as the AC source 70 illustrated. When not operating or deactivated, the “start” switch responsive to push button 65 is open as shown. Momentarily depressing push button 65 closes a circuit from source 70 through the closed contacts of the “start” switch, the liquid sensor 26 and the coil of a relay 72. When the relay 72 pulls in, it closes two normally open contacts 74 and 76 to latch the relay through the now-closed contact 74 and maintain the relay energized. This completes a power circuit via line 78 through parallel-connected pump 24 and check valve 64 to closed contact 76 and line 80, thereby completing the circuit from source 70. Accordingly, pump 24 is activated and check valve 64 opens to deliver liquid through spigot 52 to container 14. When the liquid reaches the level of the sensor 26, the proximity switch opens and relay 72 drops out, thereby terminating operation of the pump 24 and closing the check valve 64. If the user desires that the container be only partially filled, or wishes for any reason to override the automatic system and terminate operation of the pump 24, the push button 68 associated with the normally closed “stop” switch may be momentarily pressed to de-energize the coil of relay 72 and open the contacts 74 and 76.

After the container 14 has been filled to the desired level, it can be removed from the support shelf 30, transferred to and the liquid therefrom placed at the dialysis machine. Container 14 is refilled as required. Accordingly, the liquid transfer system provides an efficient, clean and safe method of rapidly transferring liquid dialysis chemicals to the dialysis machine.

It is to be understood that while certain forms of this invention have been illustrated and described, it is not limited thereto except insofar as such limitations are included in the following claims and allowable equivalents thereof.

1. A liquid transfer apparatus, comprising:
a storage drum storing a liquid therein;
a liquid transfer structure on said storage drum, having a pump, a level sensor and a riser hose member; and
a transfer container positionable on said liquid transfer structure;
said riser hose member having one end in said drum and having another end communicating with said pump;
said pump removing a desired amount of the liquid from said storage drum through said riser hose member into said transfer container.

2. A liquid transfer apparatus as claimed in claim 1 wherein said transfer container is positioned adjacent said level sensor, to prevent overflow of the liquid.

3. A liquid transfer apparatus as claimed in claim 1 wherein said liquid transfer structure includes a liquid outlet and an opening of said transfer container is positioned adjacent said liquid outlet, so that the liquid removed from said drum is pumped into said container without spillage.

4. A liquid transfer apparatus as claimed in claim 1 wherein said drum has a 55 gallon capacity.

5. A liquid transfer apparatus as claimed in claim 1 wherein said liquid transfer apparatus is for transferring dialysis chemicals from said drum.

6. A liquid transfer apparatus as claimed in claim 1 wherein said riser hose member includes a rigid riser tube inserted into said drum, a free end of said riser tube resting on or adjacent a bottom surface of said drum, allowing said drum to be completely emptied of the liquid.

7. A liquid transfer member for pumping a liquid from a storage drum to a transfer container, comprising:
a support structure adapted to be mounted to the liquid storage drum and adapted to receive the liquid transfer container;
a pump mounted at said support structure;
a level sensor mounted at said support structure; and
a riser hose member adapted to be mounted with one end in the drum and another end in communication with said pump;
said pump for removing a desired amount of liquid from the drum through said riser hose member into the liquid transfer container;
said level sensor preventing overflow of the liquid pumped into the transfer container.

8. A liquid transfer member for pumping a liquid from a storage drum to a transfer container as claimed in claim 7 wherein said liquid transfer member is for dialysis chemicals.

9. A liquid transfer member for pumping a liquid from a storage drum to a transfer container as claimed in claim 7 wherein said body member includes a shelf which is adapted to rest across the drum's lid.

10. A liquid transfer member for pumping a liquid from a storage drum to a transfer container as claimed in claim 7 wherein said body member includes a housing in which said pump and said level sensor are mounted.

11. A liquid transfer member for pumping a liquid from a storage drum to a transfer container as claimed in claim 7 wherein said body member includes a wing presenting a recessed area in which the transfer container is adapted to rest, thereby holding the container in position.

12. A liquid transfer member for pumping a liquid from a storage drum to a transfer container as claimed in claim 7 wherein said riser hose assembly includes a rigid tube having a length substantially equal to the height of the drum, to allow the drum to be completely emptied of the liquid.

13. A method of transferring liquid chemicals from a storage drum, the steps including:
inserting a riser tube assembly through the lid of the drum, with an end of the riser tube assembly being adjacent or resting on the bottom of the drum and another end of the riser tube assembly in communication with a pump,
mounting a support structure over the lid of the drum, the support structure having a level sensor and pump mounted thereto,
positioning a liquid transfer container on the support structure,
activating the pump and sensor to pump a desired amount of the liquid chemicals from the drum into the liquid transfer container, and
transporting the filled liquid transfer container to the desired location.

14. A method of transferring liquid chemicals from a storage drum as claimed in claim 13 wherein the chemicals are dialysis chemicals.

15. A method of transferring liquid chemicals from a storage drum as in claim 13 where the steps further include emptying the filled liquid transfer container at the desired location.

16. A method of transferring liquid chemicals from a storage drum as in claim 14 wherein the steps further include replacing the empty liquid transfer container on the support structure.
